(19) United States
(12) Patent Application Publication
(10) Pub. No.: US 2017/0138568 A1
(43) Pub. Date: May 18, 2017

(54) Wavelength Converting Composition, Wavelength Converting Structure, Luminescence Film Having the Wavelength Converting Structure, and Backlit Component Having the Wavelength Converting Composition

(71) Applicant: Industrial Technology Research Institute, Chutung Chen (TW)

(72) Inventors: Yi-Chun LIU, Chutung (TW); Pao-Ju HSIEH, Chutung (TW); Mei-Chih PENG, Chutung (TW); Sheng-Wei WANG, Chutung (TW)

(21) Appl. No.: 15/080,173

(22) Filed: Mar. 24, 2016

(30) Foreign Application Priority Data
Nov. 16, 2015 (TW) 104137692

(51) Int. Cl. F21V 9/16

(52) U.S. Cl. CPC F21V 9/16

(57) ABSTRACT

A wavelength converting composition is provided, including: a plurality of first cholesteric liquid crystal flakes (CLCFs); a plurality of first quantum dots; and a resin, wherein the first CLCFs and the first quantum dots are dispersed in the resin, and wherein when first light passes the wavelength converting composition, the first quantum dots are excited by the first light and emit second light having a wavelength different from a wavelength of the first light, and the second light is reflected by the first CLCFs a number of times to increase a gain. A wavelength converting structure, a luminescence film having the wavelength converting structure, and a backlit component having the wavelength converting composition are also provided.

### CROSS REFERENCE TO RELATED APPLICATIONS

This application claims priority of Taiwan Patent Application No. 104137692, filed on Nov. 16, 2015, the entirety of which is incorporated by reference herein.

### TECHNICAL FIELD

The technical field relates to a wavelength converting material and a wavelength converting composition of an internal reflection type.

### BACKGROUND

Displaying intrinsic colors vividly is the ongoing goal of pursuing for the commercial monitors. In light of the bright color from OLED, the liquid crystal displays (LCDs) limited by the backlit module color performance still have room for improvement.

Recently, the technique of quantum dots (QDs) with high color purity brings LCD a silver lining. Excited by a single short wavelength (e.g., blue light) LED, optimal quantum dots are capable of emitting different color of light (e.g., green light or red light). The backlit module of new pattern enables the 100% LCD gamut. Recently, the industries fabricate the quantum dots into two forms, such as the films (e.g., Nanosys QDEF) or quantum dots sealed in glass tubes (e.g., QD Vision tube type). Quantum dots feature in their small particle size (about 2 to 11 nm), high florescence intensity, good stability, and the ability of emitting various wavelengths of light excited by single wavelength light source, wherein the ability can further balance the RGB color of the LCD and perform the bright color easily in equivalent or superior to the OLED.

However, the quantum dots are generally made from group II-VI compounds, group III-V compounds, and group IV-VI compounds. To control the color purity, the distribution particle size must be precise and monodispersed, which results in the difficult fabrication and exorbitant price. Furthermore, the quantum efficiency is limited to the energy level of the materials, wherein the materials may have surface deficiency or modification or other condition. Different types of materials render significant variance, wherein the cadmium quantum dot (e.g., CdSe) is the best choice but is notorious for its toxicity. The efficiency of the eco-friendly non-cadmium quantum dot (e.g., InP and CuInS₂) generally still has room for improvement. Hence, evaluating the cost, reducing the amount of toxic quantum dots and improving the quantum efficiency are the first important mission.

In addition, as the normal nano-material, quantum-dots dispersing is also the key to affecting the efficiency. Corresponding to different resin, the ligands in the outer layer of the quantum dots have different designs.

Accordingly, a novel composition and structure design are desired for increasing the gain without affecting the dispersity of the quantum dots.

### SUMMARY

The present disclosure provides a wavelength converting composition, comprising: a plurality of first cholesteric liquid crystal flakes (CLCFs); a plurality of first quantum dots; and a resin, wherein the first CLCFs and the first quantum dots are dispersed in the resin, and wherein when first light passes the wavelength converting composition, the first quantum dots are excited by the first light and emit second light having a wavelength different from the wavelength of the first light, and the second light is reflected by the first CLCFs a number of times to increase a gain.

One embodiment of the disclosure provides a wavelength converting structure, which comprises: a first resist layer; and a wavelength converting layer formed on the first resist layer, wherein the wavelength converting layer includes a resin, a plurality of first CLCFs dispersed in the resin, and a plurality of the first quantum dots dispersed in the resin, and wherein when first light passes the wavelength converting layer, the first quantum dots are excited by the first light and emit second light having a wavelength different from the wavelength of the first light, and the second light is reflected by the first CLCFs a number of times to increase a gain.

Another embodiment of the disclosure provides a luminescence film comprising: the wavelength converting structure of the disclosure as previously described; and at least an optical layer formed on the wavelength converting structure. The disclosure further provides a backlit component, comprising: a transparent tubular body having a receiving space; and the wavelength converting composition of the disclosure as described above filled in the receiving space.

The wavelength converting composition, the wavelength converting structure, the luminescence film and the backlit component according to the present disclosure have at least one type of quantum dots and at least one type of the CLCFs. The CLCFs dispersed in the resin may have the same or different pitches. When the quantum dots absorb the light wave with higher energy, the electrons may produce excitations in an energy level. When the electrons decay from a high energy level to a low energy level, they emit excitation light of a longer wavelength. Under the congruent design of the wavelength of excitation light from the excited quantum dots and the reflection wavelength of the CLCFs, the excitation light from the excited quantum dots in the wavelength converting composition repeatedly contacts the CLCFs, thereby increasing the coherence, the gain and the quantum efficiency by repeatedly internal reflection provided by the corresponding CLCFs.

### BRIEF DESCRIPTION OF DRAWINGS

FIG. 1 is a schematic diagram of a wavelength converting composition of an embodiment according to the disclosure;

FIG. 2 is a schematic diagram of a wavelength converting composition of another embodiment according to the disclosure;

FIG. 3 is a cross-sectional view of a wavelength converting composition of an embodiment according to the disclosure;

FIG. 4 is a cross-sectional view of a wavelength converting composition of an embodiment according to the disclosure;

FIG. 5 is a cross-sectional view of a wavelength converting composition of another embodiment according to the disclosure;

FIG. 6 is a cross-sectional view of a luminescence film of yet another embodiment according to the disclosure;

FIG. 7 is a cross-sectional view of a luminescence film of an embodiment according to the disclosure;

FIG. 8 shows a PL spectrum from comparative 1 whereof the resin merely has quantum dots and comparative 2 whereof the reflection wavelength of the CLCFs is different from the excitation light wavelength of the quantum dots; and

FIG. 9 shows a PL spectrum from comparative 1 whereof the resin merely has quantum dot and embodiment 1 whereof the reflection wavelength of the CLCFs is the same as the excitation light wavelength of the quantum dots.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

According to a given specific embodiment below with the figures illustrating the access method of the present disclosure, a person having ordinary skill in the art is able to understand the advantages and profits of the present disclosure by referring the disclosed content in this specification. The term” size “in the specification of the present disclosure indicates the length, width or distance between two arbitrary points of the CLCFs. Meanwhile, the terms “on”, “the first” and “the second ” in the specification of the present disclosure are simply used for rendering the description clearly but not for limiting the accessible grounds of the present disclosure. Of course, the present disclosure may exert or apply other different embodiments without departing from the spirit of the present disclosure. The details in this specification may be rendered different modification and amendments basing on different view points and application.

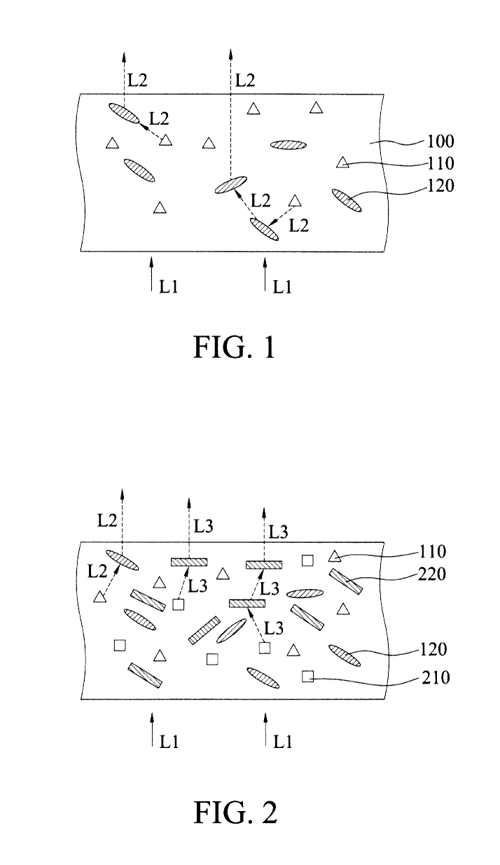

FIG. 1 is a schematic diagram of a wavelength converting composition of an embodiment according to the present disclosure. The wavelength converting composition comprises resin 100, and a plurality of first CLCFs 120 and a plurality of first quantum dots 110 dispersed in the resin 100. When first light L1 passes the wavelength converting composition, the first quantum dots 110 are excited by the first light L1 and emit second light L2 having a wavelength different from the wavelength of the first light L1. The second light L2 is reflected by the first CLCFs 120 in the wavelength converting composition a number of times and has a gain increased.

FIG. 1 illustrates an example that the wavelength converting composition is fabricated into a solid wavelength converting layer, and sets the layer on the light source or on the transmission path of the light source. In an embodiment, when the wavelength converting composition is liquid, the wavelength converting composition comprises, for example, solvents or other constituents.

When the first light L1 from the light source transmits through the wavelength converting composition according to the present disclosure, the first quantum dots 110 are excited by the first light L1, and emit the second light L2. The second light L2 may proceed the gain increment through the reflection of the first CLCFs 120 and hence increase the light density.

In an embodiment of the present disclosure, the first CLCFs account for 2 to 20 wt. %, based on the total weight of the wavelength converting composition.

The cholesterol liquid crystal flakes dispersed in the resin facilitate the reflection of the light. In an embodiment, the lateral size of the first CLCFs is twice the thickness thereof or higher to 3-5 times. In another embodiment of the present disclosure, the size of the first CLCFs is 5 to 150 μm and the thickness thereof was 2 to 11 μm.

In an embodiment of the present disclosure, the first quantum dots account for 0.5 to 10 wt. %, based on the total weight of the wavelength converting composition.

In an embodiment, the reflection wavelength of the selected first CLCFs covers the wavelength (peak value) of the light wave generated from the excited first quantum dots, which means that the reflection wavelength of the CLCFs encompasses the wavelength of the strongest light emitted from the excited quantum dots. The second light L2 generated from the first quantum dots may be repeatedly reflected by the first CLCFs 120.

In an embodiment, the first CLCFs are obtained by aligning the photo-polymerizable cholesterol liquid crystal (or the nematic liquid crystal having handedness, chiral nematic) onto a spiral structure (planar structure alignment), cured with light exposure, and crushed. According to Bragg Diffraction principle, the reflection wavelength of the cholesterol liquid crystal may be dependent on the helical pitch. Currently, CLCFs with the reflection wavelength of 30 to 2000 nm are fabricated.

According to the spirit of the present disclosure, the wavelength range of the transformed quantum dots or the reflection wavelength range of the CLCFs are not limited. In a non-limiting embodiment, a reflection spectrum of the CLCFs needs to cover the peak value of the strongest emitting light signal generated from the excited quantum dots. For instance, when the wavelength of the strongest emitting light signal generated from the excited quantum dots is 570 nm (peak value), the central reflection wavelength of the CLCFs is 570 nm (as used in the present disclosure embodiment 1), wherein the reflection spectrum is 540 nm to 600 nm.

In an embodiment, the CLCFs provide a scattering function, which not only improves a feedback gain to the quantum efficiency of the wavelength converting composition, but also increases usage of the transmitting light.

In an embodiment, the first CLCFs may have the same or opposite handedness.

When the emitting light generated from the excitable quantum dots passes the wavelength converting composition, light emitted from the excited quantum dots can be categorized as dextrorotation and levorotation. Hence, while the first CLCFs of an embodiment may have opposite handedness, each of the first CLCFs may respectively reflect excitation light having different handedness like dextrorotation and levorotation generated from quantum dots, and the internal-feedback is able to increase the gain significantly.

In an embodiment according to the present disclosure, the first quantum dots are formed from at least one group comprising group II/VI compounds, group III/V compounds, and group IV/VI compounds, wherein CdSe in the Group II/VI compounds is preferable; PbS in the Group IV/VI compounds is preferable; and InP in the Group III/V compounds is preferable. In an embodiment, the first quantum dots are in a shape like core or core-shell or appear in the form of alloy in the resin. When the first quantum dots have core-shell structure, the core/shell structure is made of CdSe/ZnS, PbS/ZnS or InP/ZnS etc., wherein CdSe/ZnS is preferable. When the quantum dots do not have a core-shell structure, the shapes of materials for forming the quantum dots may be dots, rods, polygonals, regular or irregular shapes.

In an embodiment according to the present disclosure, the resin 100 is transparent, for example, on selecting resin with light transmittance higher than 80 wt. % or higher than 85 wt. %. It is preferable to select the one higher than 90 wt. %. In a non-limiting embodiment, the resin is selected from at least one group comprising epoxy resins, acrylic resins, polyurethane acrylates, polycarbonates, polyesters, polyimides, polyvinylidene difluorides (PVDF) and cholesterol type liquid crystal(cholesteric liquid crystal, CLC) resins.

In an embodiment, the resin 100 may be selected from the cholesterol liquid crystal resin. The cholesterol liquid crystal resin not only provides the same reflection wavelength with as the first CLCFs, its handedness can be the same or opposite to the CLCFs. When the handedness of the cholesterol liquid crystal resin and the handedness of the first CLCFs were opposite, the dextrorotation and levorotation reflected from the quantum dots are further differentiated and reinforced the effect of gain increment of the first light to generate internal feedback, accordingly improves the wavelength converting effect of the wavelength converting composition according to the present disclosure.

Referring FIG. 2, in another embodiment of a wavelength converting composition according to the present disclosure, the wavelength converting composition further comprises a plurality of second quantum dots 210 and a plurality of second CLCFs 220 dispersed in the resin 100. When the first light L1 is emitted from a light resource transmitted through the wavelength converting composition according to the present disclosure, the first quantum dots 110 and the second quantum dots 210 were respectively excited by the first light L1 and emitted the second light L2 and the third light L3, which are different from the first light L1. The second light L2 and the third light L3 may undergo reflection through the first CLCFs 120 and the second CLCFs 220, respectively, so as to achieve the effect of gain increment and to increase light density thereof.

In an embodiment according to the present disclosure, based on the total weight of the wavelength converting composition, the first quantum dots and the second quantum dots account for 1 to 20 wt. %.

In an embodiment, the second quantum dots are formed by at least one group comprising Group II/VI compounds, Group III/V compounds and Group IV/VI compounds. The selection details of the materials were the same as of the first quantum dots, further description hereby omitted.

In an embodiment according to the present disclosure, based on the total weight of the wavelength converting composition, the first CLCFs and the second CLCFs account for 4 to 40 wt. %.

The cholesterol liquid crystal in the form of flakes dispersed in the resin facilitates reflection of the light. Lateral size of the second CLCFs is twice, or 3-5 times the thickness thereof. In an embodiment according to the present disclosure, geometric mean diameter of the second CLCFs is 5 to 150 μm, and the thickness thereof is 2 to 11 μm.

On selecting the materials of the second CLCFs, the requisite is that the reflection wavelength of the second CLCFs and the wavelength of the light wave generated from the excited second quantum dots are the same. Hence, the third light L3 generated from the second quantum dots is repeatedly reflected by the second CLCFs 220.

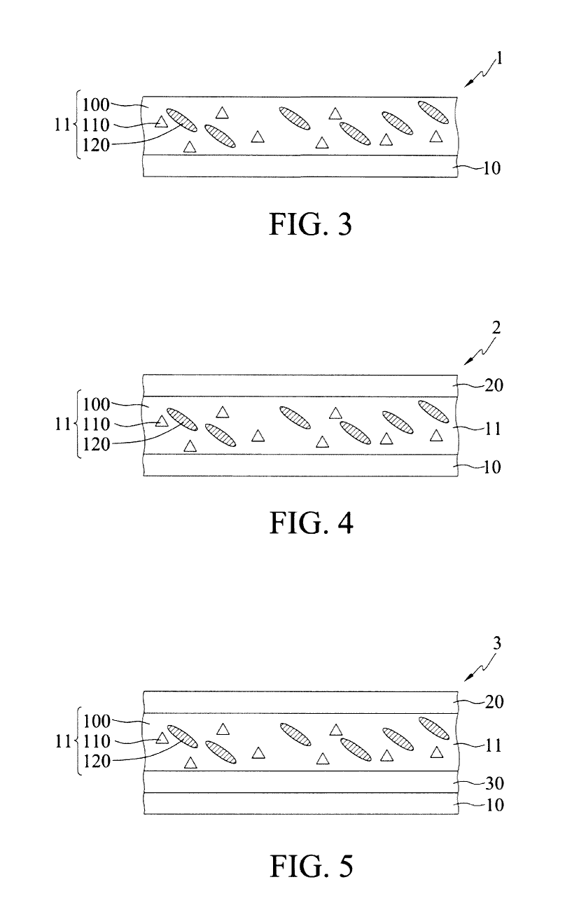

FIG. 3 is a cross-sectional view of a wavelength converting structure 1 of an embodiment according to the present disclosure. The wavelength converting structure 1 comprises: a first resist layer 10; and a wavelength converting layer 11 formed on the first resist layer 10, wherein the wavelength converting layer 11 comprises resin 100, and a plurality of first CLCFs 120 and a plurality of first quantum dots 110 dispersed in the resin 100.

When the first light passes the wavelength converting layer 11, the first quantum dots are excited by the first light and emit the second light having a wavelength different from a wavelength of the first light, and the second light is reflected by the first CLCFs in the wavelength converting layer 1 a number of times and has a gain increased. In an embodiment, the wavelength converting layer is 3 to 20 μm in thickness. Based on the total weight of the wavelength converting layer 1, the first CLCFs account for 2 to 20 wt. %, and the first quantum dots account for 0.5 to 10 wt. %.

In a further embodiment, the wavelength converting layer 1 further comprises a plurality of second CLCFs and a plurality of second quantum dots dispersed in the resin. When the first light passes the wavelength converting layer 1, the second quantum dots are excited by the first light and emit third light having a different wavelength from the first light, and the third light is reflected by the second CLCFs in the wavelength converting layer 1 a number of times and has a gain increased. In an embodiment, based on the total weight of the wavelength converting layer 1, the first CLCFs and the second CLCFs account for 4 to 40 wt. %.

In the wavelength converting structure according to the present disclosure, the resin 100 is transparent, for example, on selecting resin with light transmittance higher than 80 wt. % or higher than 85 wt. %. It was preferable to select the one higher than 90 wt. %. In non-limiting embodiment, the resin is selected from at least one group comprising epoxy resins, acrylic resin, polyurethane acrylates, poly carbonates, polyesters, polyimides, polyvinylidene difluorides (PVDF) and cholesterol type liquid crystals (cholesteric liquid crystal, CLC) resins.

In an embodiment, the resin 100 may be selected from the cholesterol liquid crystal resin. The cholesterol liquid crystal resin provides the same reflection wavelength with the first CLCFs, and has handedness the same or opposite to that of the CLCFs. When the handedness of the cholesterol liquid crystal resin and the handedness of the first CLCFs were opposite, the dextrorotation and levorotation reflected from the quantum dots could be further differentiated and further reinforced the effect of gain increment of the first light to generate internal feedback. Accordingly the wavelength converting effect of the wavelength converting composition according to the present disclosure is improved.

In an embodiment, the first resist layer 10 were made from polyethylene terephthalate (PET), glasses, dielectric material, oxides (for example, silicon oxide (SiO₂,Si₂O₃), titanium oxides, aluminum oxides, and the optimal combination of the two material.

Referring FIG. 4, a wavelength converting structure 2 according to the present disclosure further comprises the second resist layer 20 formed on the wavelength converting layer 11, and the wavelength converting layer 11 is sandwiched between the first resist layer 10 and the second resist layer 20. In an embodiment, the second resist layer 20 is made from polyethylene terephthalate (PET), glasses, dielectric materials, oxides (for example, silicon oxide (SiO₂, Si₂O₃), titanium oxides, aluminum oxides, and the optimal combination of the two materials.

Referring FIG. 5, the wavelength converting structure 3 according to the present disclosure further comprises a substrate 30 disposed between the first resist layer 10 and wavelength converting layer 11.

According to the present disclosure, the resist layer setting like the first resist layer 10 and the second resist layer 20 is able to protect a plurality of quantum dots in the wavelength converting layer 11, for example, preventing a plurality of the first quantum dots 110 from the influence of ambient water vapor and oxygen. The substrate 30 is for the formation of the wavelength converting layer 11, especially under the condition that the resin of the wavelength converting layer 11 is the cholesterol liquid crystal resin. If the first resist layer 10 of accessible alignment treatment is selected, the substrate 30 can be omitted, and wavelength converting layer 11 can be directly formed onto the first resist layer 10. In an embodiment, the substrate 30 is made of polymethyl methacrylate (PMMA), polystyrene (PS), methyl styrene (MS), polycarbonate (PC), polyethylene terephthalate (PET) or Triacetate Cellulose (TAC).

In an embodiment, the substrate 30 is 10 to 200 μm in thickness.

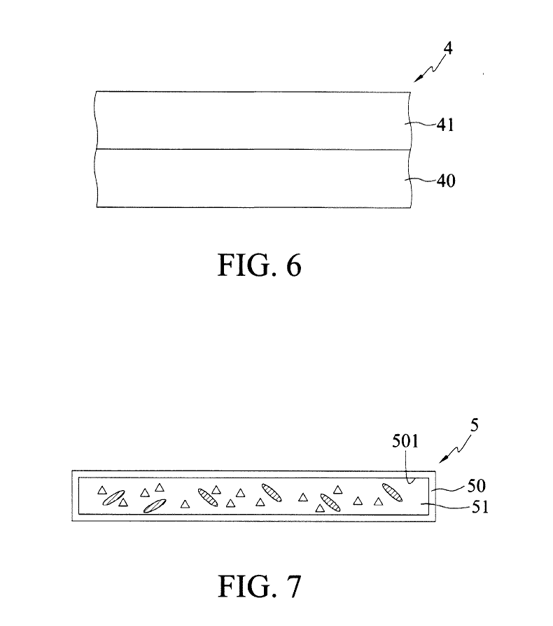

Referring to FIG. 6, the present disclosure provides a luminescence film 4 comprising the wavelength converting structure 40 and at least one optical layer 41 formed on the wavelength converting structure 40. In an embodiment, the optical layer 41 is selected from a light focusing film having a prism sheet structure, a cholesterol liquid crystal reflection polarizing film, or a reflection polarizing film having a multi-layer structure, in order to significantly reduce the usage of the quantum dots and meanwhile maintain extreme high quantum efficiency for improving the gain of light emitting.

FIG. 7 shows the application of the wavelength converting composition according to the present disclosure to an edge-lit backlit module in a monitor, which is a backlit component 5 comprising a transparent tubular body 50 that has a receiving space 501, and the wavelength converting composition 51 according to the present disclosure which fills the receiving space 501. The material of the transparent tubular body 50 may have light transmittance higher than 80 wt. % or higher than 85 wt. %, more preferable the one higher than 90 wt. %. For instance, the transparent tubular body 50 is a glass tube.

### Embodiment 1

### The Wavelength Converting Composition According to the Present disclosure

2 wt. % of CdSe/ZnS QD (quantum dots) and 10 wt. % of CLCFs (cholesteric liquid crystal flakes with reflective wavelength of 570 nm, commercially available from LCP Technology GmbH HELICONE® HC Jade) were added to toluene solution of the photo-curable resin UV298 (commercially available from CHEM-MAT Technologies Co. Ltd.) to form a wavelength converting composition of the present disclosure, of which the quantum dots and the CLCFs were dispersed evenly in transparent resin. The quantum dots are capable of absorbing a blue LED light source in the range of 440 nm to 460 nm and emitting green light having a central excitation light wavelength of 570 nm.

A PET film in thickness of 50 μm is provided as a substrate, and the wavelength converting composition made in preparation 1 is spin-coated at 1500 rpm on the substrate. A wavelength converting layer having a thickness of 10 μm is obtained after the substrate is cured into a film for 20 seconds under UV light with 100 W/cm².

### Comparative 1

The fabrication method was the same as that used in embodiment 1 except that the fabrication method does not have the CLCFs.

### Comparative 2

The fabrication method was the same as that used in embodiment 1 except that in the fabrication method the CLCFs of the reflection wavelength 570 nm is replaced by the CLCFs (LCP Technology GmbH HELICONE® HC Scarabeus) of the reflection wavelength 510 nm.

### Assessment:

The sample was shined by blue light LED of 460 nm and recorded an excitation light spectrum delivered by USB 4000 light spectrometer of Ocean Optics Company. And the wavelength converting structure of embodiment 1, comparative 1 and 2 light were exerted excited fluorescence (photoluminescence, hereinafter referred to PL) spectrum analysis.

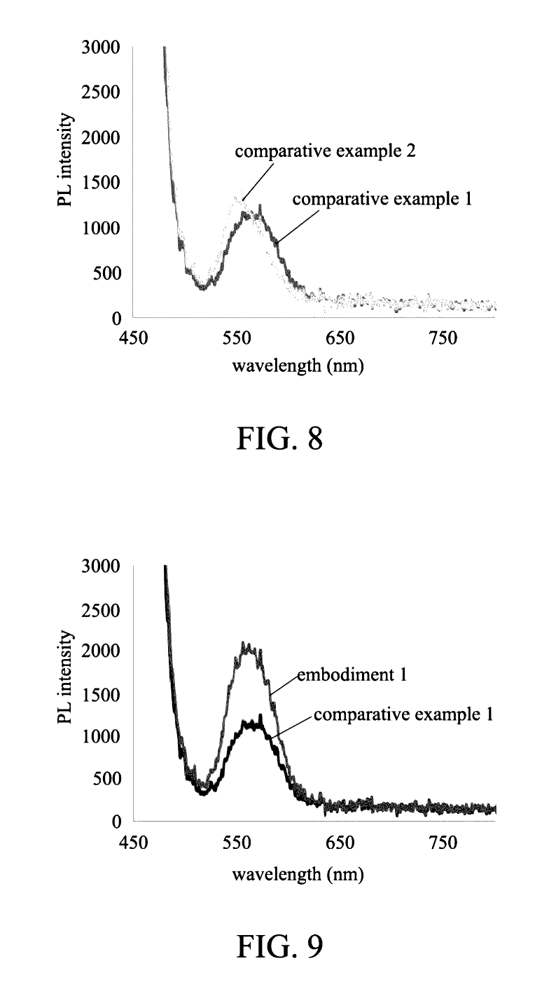

FIG. 8 shows a PL spectrum of the wavelength converting structure of comparative 1 and comparative 2. It is showed that the peak value is generated in PL wavelength of 540 nm to 560 nm. However, contrary to comparative 1, though comparative 2 comprises the CLCFs, and for the reason that the reflection wavelength of the CLCFs and the excitation light wavelength generated by the quantum dots are different, it was unable to proceed repeatedly reflection by the CLCFs. The PL spectrums of the two comparative were similar but the lighting gain was not shown therein.

Referring to FIG. 9, the peak value is generated in PL wavelength interval of 540 nm to 560 nm in embodiment 1 according to the present disclosure. In contrast, PL intensity of embodiment 1 according to the present disclosure is about twice the comparative 1. This showed when the reflection wavelength of the CLCFs and the wavelength of light wave generated from excited quantum dots are the same, the excitation light generated from quantum dots is able to be repeatedly reflected by the CLCFs, the excitation light density is improved, and the gain of light emitting is increased.

In summary, in the present disclosure, under the congruent design of the wavelength of excitation light from the excited quantum dots and the reflection wavelength of the CLCFs, the excitation light from the excited quantum dots in the wavelength converting composition contacts repeatedly to the CLCFs, and it is able to increase the coherence, the gain and the quantum efficiency by repeatedly internal reflection provided by the corresponding CLCFs.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A wavelength converting composition, comprising:
a plurality of first cholesteric liquid crystal flakes (CLCFs);
a plurality of first quantum dots; and
a resin,
wherein the first CLCFs and the first quantum dots are dispersed in the resin, and
wherein when first light passes the wavelength converting composition, the first quantum dots are excited by the first light and emit second light having a wavelength different from a wavelength of the first light, and the second light is reflected by the first CLCFs a number of times to increase a gain.

2. The wavelength converting composition of claim 1, wherein the first CLCFs account for 2 wt. % to 20 wt. %, based on a total weight of the wavelength converting composition.

3. The wavelength converting composition of claim 1, wherein the first quantum dots account for 0.5 wt. % to 10 wt. %, based on a total weight of the wavelength converting composition.

4. The wavelength converting composition of claim 1, further comprising:
a plurality of second CLCFs dispersed in the resin; and
a plurality of second quantum dots dispersed in the resin,
wherein when the first light passes the wavelength converting composition, the second quantum dots are excited by the first light and emit third light having a wavelength different from the wavelength of the first light, and the third light is reflected by the second CLCFs a number of times to increase a gain.

5. The wavelength converting composition of claim 4, wherein the first CLCFs and the second CLCFs account for 4 wt. % to 40 wt. %, based on a total weight of the wavelength converting composition.

6. The wavelength converting composition of claim 4, wherein at least one of the first CLCFs and the second CLCFs is 5 μm to 150 μm in size and 2 μm to 11 μm in thickness.

7. The wavelength converting composition of claim 4, wherein at least one of the first quantum dots and the second quantum dots is selected from the group consisting of Group II/VI compounds, Group III/V compounds and Group IV/VI compounds.

8. The wavelength converting composition of claim 1, wherein the resin is a cholesterol liquid crystal resin, and a handedness of the cholesterol liquid crystal resin is opposite to a handedness of the first CLCFs.

9. A wavelength converting structure, comprising:
a first resist layer; and
a wavelength converting layer formed on the first resist layer, wherein the wavelength converting layer includes:
a resin,
a plurality of first cholesteric liquid crystal flakes (CLCFs) dispersed in the resin, and
a plurality of first quantum dots dispersed in the resin,
wherein when first light passes the wavelength converting layer, the first quantum dots are excited by the first light and emit second light having a wavelength different from a wavelength of the first light, and the second light is reflected by the first CLCFs a number of times to increase a gain.

10. The wavelength converting structure of claim 9, further comprising a second resist layer formed on the wavelength converting layer, wherein the wavelength converting layer is sandwiched between the first resist layer and the second resist layer.

11. The wavelength converting structure of claim 9, further comprising a substrate formed between the first resist layer and the wavelength converting layer.

12. The wavelength converting structure of claim 9, wherein the wavelength converting layer is 3 μm to 20 μm in thickness.

13. The wavelength converting structure of claim 9, wherein the first CLCFs account for 2 wt. % to 20 wt. %, based on a total weight of the wavelength converting layer.

14. The wavelength structure of claim 9, wherein the first quantum dots account for 0.5 wt. % to 10 wt. %, based on a total weight of the wavelength converting layer.

15. The wavelength converting structure of claim 9, wherein the wavelength converting layer further comprises a plurality of second CLCFs and a plurality of second quantum dots dispersed in the resin, and wherein when the first light passes the wavelength converting layer, the second quantum dots are excited by the first light and emit third light having a wavelength different from a wavelength of the first light, and the third light is reflected by the second CLCFs a number of times to increase a gain.

16. The wavelength converting structure of claim 15, wherein the first CLCFs and the second CLCFs account for 4 wt. % to 40 wt. %, based on a total weight of the wavelength converting layer.

17. The wavelength converting structure of claim 9, wherein the resin is a cholesterol liquid crystal resin, and a handedness of the cholesterol liquid crystal resin is opposite to a handedness of the first CLCFs.

18. A luminescence film, comprising:
the wavelength converting structure of claim 9; and
at least one optical layer formed on the wavelength converting structure.

19. The luminescence film of claim 18, wherein the at least one optical layer is a light focusing film having a prism sheet structure, a reflection polarizing film of cholesterol liquid crystals, or a reflection polarizing film having a multi-layer structure.

20. A backlit component, comprising:
a transparent tubular body having a receiving space; and
the wavelength converting composition of claim 1 filled in the receiving space.
